(19) United States
(12) Patent Application Publication
(10) Pub. No.: US 2026/0288784 A1
(43) Pub. Date: Sep. 24, 2026

(54) System and Method for Configuring Workflows with Multiple Large Language Models

(71) Applicant: Makebell Limited, Hong Kong (HK)

(72) Inventors: Kaidrian Yu, Hong Kong (HK); Ronald Yu, Hong Kong (HK)

(21) Appl. No.: 19/441,830

(22) Filed: Jan. 6, 2026

Related U.S. Application Data
(60) Provisional application No. 63/743,646, filed on Jan. 10, 2025.

(51) Int. Cl. G06F 16/3329; G06F 40/56

(52) U.S. Cl. CPC G06F 16/3329; G06F 40/56

(57) ABSTRACT

A method and system for configuring workflows using multiple large language models (LLMs) includes receiving configuration settings for multiple modules including user message modules, LLM processing modules, search modules, and presentation modules. The system assigns global and local unique identifications to each module and defines data flow between modules using a flowchart. The method includes validating LLM outputs against predefined schemas and automatically correcting non-conforming outputs using additional LLM processing. The system generates debug information for each module and manages sensitive information through dedicated removal modules. Database schemas are dynamically generated based on document analysis, enabling efficient storage and retrieval of processed information across multiple specialized databases. The system provides configurable user interfaces adaptable for different professional applications while maintaining consistent output quality through automated validation processes.

### CROSS REFERENCE TO RELATED APPLICATION

The present application claims the benefit of U.S. Provisional Patent Application No. 63/743,646 filed on Jan. 10, 2025, the contents of which are incorporated herein by reference in their entirety.

### FIELD OF THE INVENTION

The present invention relates generally to computing systems and, more particularly, to a method for configuring a computing system to generate reports using large language models (LLMs). This method integrates multiple processing and search modules, along with presentation modules, to efficiently generate reports by combining outputs from LLM engines and database searches. The invention specifically addresses the challenges of coordinating multiple LLM instances, managing data flow between various modules, ensuring output consistency, and providing flexible configuration options for different use cases. The system is particularly applicable in professional environments requiring sophisticated document processing and information analysis capabilities.

### BACKGROUND

Large language models (LLMs) have demonstrated significant utility in understanding and generating human language. However, utilizing LLMs effectively in applications requiring data integration from multiple sources, including structured databases and document repositories, remains a challenge. Existing systems either require manual orchestration of the interactions between the user, LLM, and external data sources, or offer limited configurability for dynamic and efficient report generation.

Current solutions often lack the ability to effectively coordinate multiple LLM instances and manage their interactions with various data sources. While some systems provide basic integration capabilities, they typically do not offer the flexibility needed to handle complex workflows involving multiple processing steps and data transformations. Additionally, existing solutions often struggle with maintaining consistent output formats, managing sensitive information, and providing comprehensive debugging capabilities.

Furthermore, current implementations frequently face challenges in handling large-scale document processing, particularly when dealing with specialized documents such as patents, legal documents, or medical records. The absence of efficient mechanisms for document classification, information extraction, and structured storage limits the practical utility of these systems in professional environments.

Another significant limitation of existing systems is their inability to dynamically adapt to different types of queries and data sources while maintaining consistent output quality. This inflexibility makes it difficult to deploy these systems across various use cases and industries without substantial modifications.

### SUMMARY OF THE INVENTION

The present invention provides a method for configuring a computing system to generate reports using an LLM. The system integrates several modules, including a user message module, a plurality of LLM processing modules, a plurality of search modules, and at least one presentation module. The configuration includes receiving specific settings for each module and defining the data flow between the modules using a flowchart. The system is designed to execute this flowchart, enabling the user message module to interact with the LLM processing and search modules to combine and present the outputs in a cohesive report.

In one embodiment, the method includes configuring the system to generate debug information for each module, providing insight into the inputs and outputs of the various components. Additionally, each module is assigned both a global unique identification (GUID) and a local unique identification (LUID), which allows for flexible naming and module management within the system.

In another embodiment, the method includes configuring the system to ensure the schema of LLM outputs matches the intended format of the LLM outputs. This is achieved through a validation process that can automatically correct non-conforming outputs using additional LLM processing.

The invention further provides capabilities for handling sensitive information through dedicated removal modules, enabling secure processing of confidential documents. The system can be configured to maintain audit trails of sensitive information handling while ensuring compliance with various data protection regulations.

The method also includes features for dynamic database schema generation and management, allowing the system to efficiently store and retrieve information from multiple specialized databases. This capability is particularly useful when processing large volumes of documents with varying structures and content types.

Furthermore, the invention includes configurable user interfaces that can be adapted for different use cases, from patent searches to medical diagnosis support, while maintaining consistent interaction patterns and output quality. The system's modular architecture allows for easy extension and customization to meet specific industry requirements while leveraging the core capabilities of LLM processing and data integration.

These features collectively enable the creation of sophisticated workflows that can handle complex document processing tasks while maintaining flexibility, security, and efficiency in various professional applications.

### BRIEF DESCRIPTION OF THE DRAWINGS

FIG. 1 illustrates a workflow comprising multiple AI modules according to one embodiment of the present invention.

FIG. 2 illustrates a system configuration comprising workflow configurations and third-party API configurations according to one embodiment of the present invention.

FIG. 3 illustrates a computing system capable of realizing workflows according to one embodiment of the present invention.

FIG. 4 illustrates a flowchart ensuring LLM module outputs conform to an output schema according to one embodiment of the present invention.

FIG. 5 illustrates a flowchart of storing document information to databases according to one embodiment of the present invention.

FIG. 6 illustrates an alternative flowchart for storing document information in databases according to one embodiment of the present invention.

FIG. 7 illustrates a flowchart of creating database schema and storing document information according to one embodiment of the present invention.

FIG. 8 illustrates a flowchart of a patent search workflow according to one embodiment of the present invention.

FIG. 9 illustrates an alternative flowchart of a patent search workflow according to one embodiment of the present invention.

FIG. 10 illustrates a workflow with sensitive information removal capability according to one embodiment of the present invention.

FIG. 11 illustrates a workflow of processing affidavits according to one embodiment of the present invention.

FIG. 12 illustrates a user interface for patent search according to one embodiment of the present invention.

FIG. 13 illustrates a database schema according to one embodiment of the present invention.

### DETAILED DESCRIPTION

A workflow coordinates a plurality of AI modules to work together to complete a task, and each AI module may perform different parts of the task. In one illustration, a user wants to have a report on environmental conservation advancements. The user first submits a query through the user message module, asking for a detailed report on recent advancements in environmental conservation. Then the user module formats the query and forwards it to an LLM module tasked with generating a summary response. Simultaneously, a search module retrieves relevant documents from an academic database, filtering articles on environmental conservation advancements. Then another LLM module generates a summary based on relevant documents from the search module and formats them into a cohesive report. The final report is then displayed to the user through a presentation module.

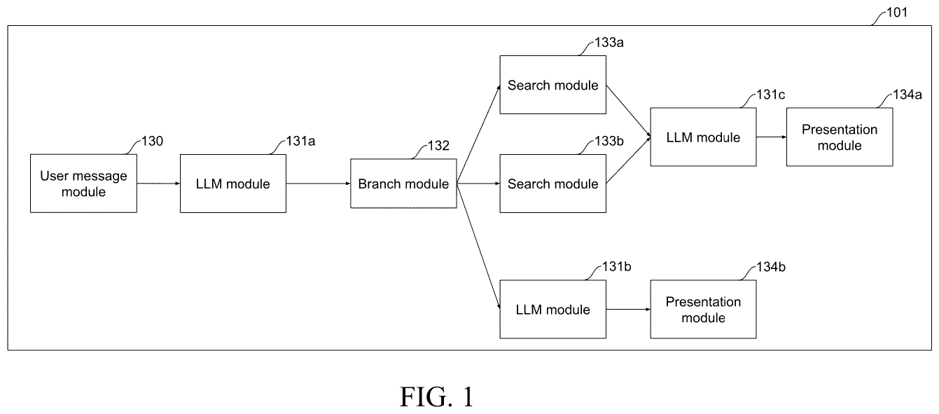

FIG. 1 illustrates another workflow, workflow 101 comprising of AI modules as one of embodiments of the present invention. User message module 130 receives a message from a user or from a system. The user and the system may be located locally or remotely. LLM module 131a analyzes the message according to an instruction. The instruction is then sent to branch module 132. Branch module 132 will forward the message according to the instruction to at least one of search module 133a, search module 133b and LLM module 131b.

In one example, LLM module 131 may select one of three choices, namely “translation”, “summarization” and “creative writing” according to the message received by user message module 130. If LLM module 131 selects “translation”, branch module 132 will send the message received by user module 130 and output of LLM module 131 to search module 133a. If LLM module 131 selects “summarization”, branch module 132 will send the message received by user module 130 and output of LLM module 131 to search module 133b. If LLM module 131 selects “creative writing”, branch module 132 will send the message received by user module 130 and output of LLM module 131 to LLM module 131b. There is no limitation that branch module 132 is limited to accepting text strings, other types of data like numbers, JSON data, XML data, and dates are possible.

Search module 133a may search against a database according to its instruction received while search module 133b may search against a different database according to its instruction received. There is no limitation that the database being searched against by search modules 133a and 133b are different. The search results from search modules 133a and 133b are then processed by LLM module 131c. The output of LLM module 131c is then sent to presentation module 134a, which will send the outputs of LLM module 131c to a user or a system.

LLM module 131b receives the outputs of LLM module 131a through branch module 132 and processes the outputs according to its prompt. After the processing, outputs of LLM module 131b is sent to presentation module 134b, which will send the outputs of LLM module 131c to a user or a system.

Message module 130 may be realized by Python programming language or similar programming language to receive messages through an application programmable interface (API). It receives user input in the form of messages. This module acts as the entry point for users to submit requests, define parameters, and provide additional context necessary for the final outputs provided through presentation modules, such as presentation modules 134a and 134b. The messages may be in various formats, including text, image, video, audio or speech, and relay these messages to subsequent processing modules.

LLM modules 131a-131c are configured to interact with LLM engines. These modules are responsible for sending prompts and other parameters to the LLM and receiving the responses generated by the LLM. Well known LLM engines include OpenAI ChatGPT API service, Anthropic Claude 3.5 Sonnet API service and Mistral AI service. An LLM module may be realized by Python programming language or similar programming language to interact with the LLM engine through the LLM engine's API. For example, LLM module 131a may use “openai” Python API library to connect to and interact with ChatGPT while LLM modules 131b and 131c may use Python code to generate HTTPS protocol calls to communicate with Azure LLM services. Each LLM module should operate independently and is configured with respective LLM configurations.

Branch module 132 is to determine which module to send inputs received to. A branch module may be realized deterministically by using Python programming language or similar programming language to evaluate conditions. It may also be realized by using an LLM module. Each branch module should operate independently.

Search modules 133a and 133b are configured to interact with connected databases. A search module may be realized by Python programming language or similar programming language to interact with databases, such as using Python Elasticsearch Client to interact with a Elasticsearch database and SQLAlchemy to interact with SQL databases. Each search module should operate independently and is configured with respective search module configurations.

Presentation modules 134a and 134b are to combine outputs from other modules and send to a user or a system. A presentation module may be realized deterministically by using Python programming language or similar programming language to ensure the data is sent to the user or the system following a rigid format, which is provided by presentation module configurations 205. It may also be realized by using an LLM module to convert outputs from other modules to meet the rigid format. The data sent to the user and system may be in JSON format, XML format, CSV format or any other format specified.

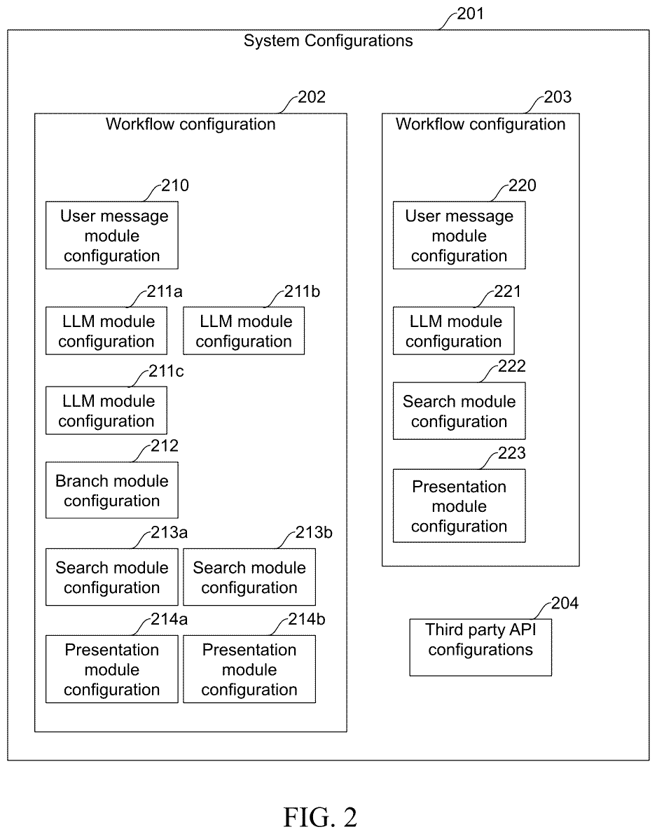

FIG. 2 illustrates system configuration 201 comprising workflow configurations 202 and 203, and third-party API configurations 204. Configuration storage 201 is to store configurations of all workflows in a system and may also include other configurations that facilitate workflow operations, such as third party API configurations 204. There may be a plurality of workflows running concurrently in the system. Each workflow has its own workflow configurations, such as workflow configuration 202 and 203. A workflow configuration is comprised of configurations for all AI modules of a workflow. For example, workflow configuration 202a includes message module configuration for user message module 130, LLM module configurations 211a, 211b and 211c for LLM modules 131a, 131b and 131c respectively, branch module configuration 212 for branch module 132, search module configurations 213a and 213b for search modules 133a and 133b respectively, and presentation module configurations 214a and 214b for presentation modules 134a and 134b respectively.

Use message module configurations 210 has the configuration for user message module 130 and may specify the source and type of messages allowed to be received from a user or from another system.

LLM module configurations 211a-211c have the configurations for LLM modules 131a-131c respectively. The configurations may include LLM information, LLM engine information, system prompt, user prompt, and output format. The prompt may be pre-determined and received from prior modules. For example, LLM module configuration 211c may specify that the user prompt of LLM module 131c is a combination of search results from search module 133a or search module 133b and outputs of LLM module 131a. LLM module configuration 211c may also provide the system prompt to LLM module 131c. The system prompt may be entered by a prompt engineer when workflow 101 is first created.

An LLM module configuration may further comprise an output schema that an LLM module should follow the output schema to provide the output. For example, OpenAI has structured output in its ChatGPT API to ensure outputs from LLM meet the output schema. LLM module configuration may also comprise temperature, maximum tokens, penalty and other parameters for an LLM.

Presentation module configuration 214a and 214b may specify the output formats of presentation module 134a and 134b. There is no limitation to the output format. Output formats may include JSON format, XML format, CSV format, binary data, text strings, audio, video, and image.

Branch module configuration 212 may specify the branch condition and branch results for branch module 132. For example, it is configured with “translation”, “summarization” and “creative writing” as the branch conditions. The branch results may be the first pathway leading to search module 133a, second pathway leading to search module 133b and third pathway leading to LLM module 131b.

Search module configurations 213a and 213b provide database configurations to search modules 213a and 213b. The configurations should include the database connection information and the database commands. The database commands may specify tasks to be performed, like inserting data, modifying data and searching.

Workflow configurations 202 may hold other configurations of the workflow illustrated in FIG. 1. The configurations include the relationship among the modules, sequences of events and other information that facilitate the operation of the workflow. For example, workflow configuration 202 may have configurations of the pathways between the user message module 130, LLM modules 131a-131c, branch module 132, search modules 133a-133b, and presentation modules 134a-134b. In one example, FIG. 1 may be illustrated by a graphic user interface that a user may drag and drop modules and draw lines among the modules to build the workflow, the position of modules on the screen and text descriptions of modules may also be stored in a workflow configuration.

Intermediate data of a workflow for debugging purposes is captured. Workflow configuration 201 is configured to generate debug information based on intermediate data for each module. This debug information provides valuable insights into the system's operations, such as for troubleshooting issues or refining the system's configuration. Intermediate data includes data sent from one module to another module, data sent to and received from LLM engines, data sent to and received from databases, data sent to and received from external APIs. For example, the data sent by LLM module 131a to branch module 132 is intermediate data. Intermediate data is usually not displayed to the user or stored. Intermediate data is useful for debugging purposes and may be stored in a database or a file. There is no limitation on how long intermediate data should be stored. It is recommended the intermediate should be stored in a shorter time period than the storage time period of the user's message received by the user message module 130 and outputs from presentation module 134a and 134b.

Workflow configuration 203 holds the configuration of another workflow that can be performed in the same system. For illustration purposes, the workflow has a user message module, an LLM module, a search module and a presentation module. User message module configuration 220, LLM module configuration 221, search module configuration 222, and presentation module configuration 223 have the configurations for such user message module, LLM module, search module and presentation module respectively.

Third party API configurations 204 may have configurations for communicating with third party APIs. For example, third party API configurations 204 may have the uniform resource locators (URLs) and API keys for OpenAI ChatGPT API service, Anthropic Claude 3.5 Sonnet API service and Mistral AI service.

System configuration 201 may have configurations of the system performing the workflows. For example, it may have user information, backup schedule configuration, security configuration and other configurations to facilitate the operation of the system.

Each module in the system is assigned a global unique identification (GUID) to ensure that it is uniquely identifiable within the system. Additionally, the system allows for each module in a workflow to be assigned a local unique identification (LUID) for internal referencing and naming flexibility. The use of both global and local IDs allows for precise control over each module's operation and integration into the broader system architecture. For example, LLM modules 131a, 131b and 131c are each assigned with a GUID and LUID. An LLM module of another workflow may not be assigned with the same GUID of LLM module 131a but may be assigned with the same LUID of LLM module 131a.

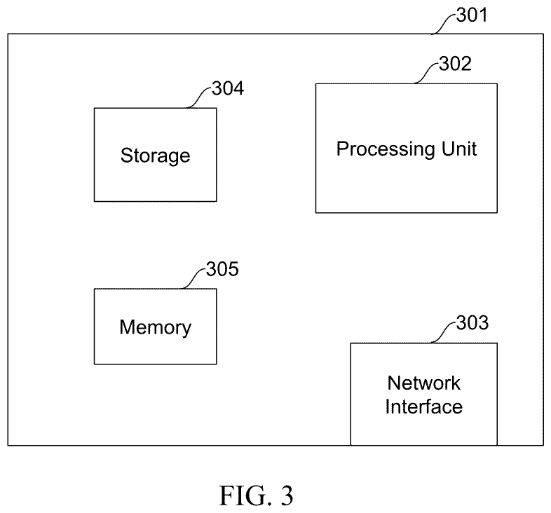

FIG. 3 illustrates computing system 301 that is capable of realizing workflows. Computing system 301 comprises processing unit 302, network interface 303, storage 304 and memory 305.

Computing system 301 is representative of a general-purpose computing platform in which embodiments of the present invention may be implemented. Computing system 301 is described as an example implementation, without limitation to the specific configuration shown. In the depicted embodiment, computing system 301 includes processing unit 302, which may comprise one or more processors, including multi-core processors or heterogeneous processor systems. Network interface 303 provides communication capabilities through various means including but not limited to WiFi and Ethernet connections. Storage 304, which may include hard disk drives or solid-state drives, provides non-volatile storage for system software and application programs. Memory 305, such as DRAM, provides volatile storage for program execution and data processing.

An operating system runs on processing unit 302, coordinating and controlling the various components of computing system 301. The operating system may be any commercially available system suitable for the computing platform. Application programs and system software may be stored in storage 304 and loaded into memory 305 for execution by processing unit 302.

The specific implementation of computing system 301 may vary, with components being added, removed, or modified without departing from the general description provided herein. Computing system 301 may be implemented in various forms including but not limited to personal computers, servers, mobile devices, or virtualized environments.

System configurations 201 may be stored in storage 304. The software codes that perform the functions of the AI modules, like LLM module and branch module, may also be stored in storage 304. When a workflow is to be executed, the corresponding configurations and software code may first be loaded to memory 305 and then processed by processing unit 302. When an AI module needs to communicate with other systems, like communicating to ChatGPT API service, the communication may be performed through network interface 303.

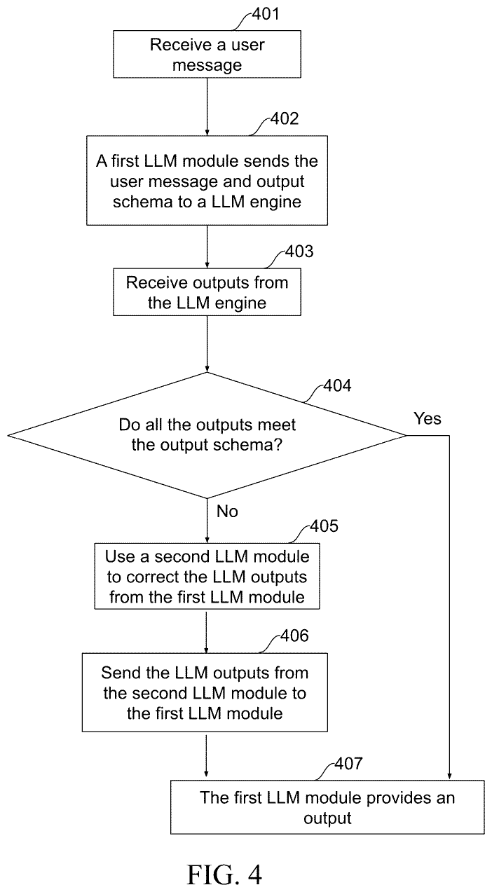

FIG. 4 illustrates one of the embodiments of the present invention to ensure outputs from a LLM module conform to the output schema specified in the LLM module configurations of the LLM module. For example, LLM module configurations for LLM module 131a specify the output schema to be in JSON format, should be an object having one key and one value only, the key should be named “decision”, and the type of the value should be string.

In step 401, a message module receives a user message from a user. In step 402, a first LLM module sends the user message along with a system prompt and output schema to a LLM engine. An output schema may be in JSON format, XML format, or other commonly acceptable format.

In step 403, the system that executes the workflow receives outputs from the LLM engine. In step 404, the system determines if all the outputs from the LLM engine meet the output schema. There are myriad ways to determine whether the output schema is met. In one example, the outputs may be converted to JSON format using a command or a library, such as the Python JSON library. If the conversion fails, then the system may determine that the output schema is not met. In another example, Python lxml library may be used to convert the output to XML format. Similarly, if the conversion fails, then the system may determine that the output schema is not met. If the conversion succeeds, step 407 will be performed.

In step 405, if not all the outputs meet the output schema, the system will use a second LLM module to correct the outputs to ensure the output schema is met. Then the outputs from the second LLM will be sent back to the first LLM module at step 406. Then the first LLM module will replace its output with the outputs from the second LLM. In step 407, the first LLM module will provide the output to the next module, such as branch module 132.

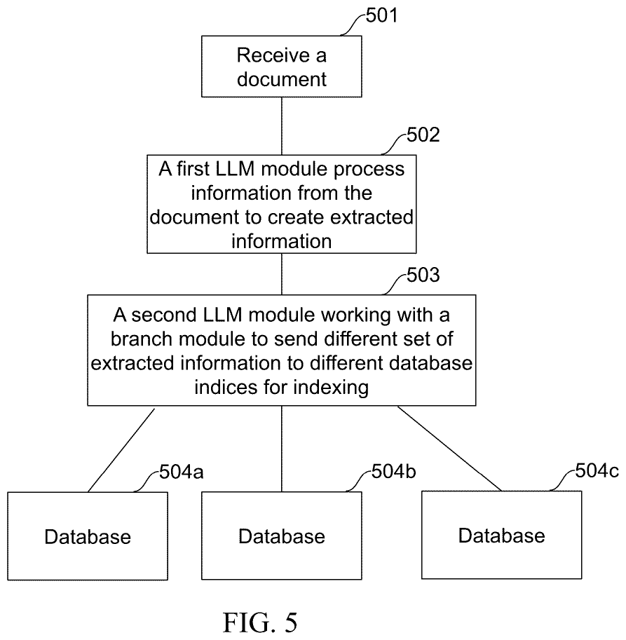

FIG. 5 illustrates one of embodiments of the present invention of a workflow running in a system to store information of a document to databases. The information may be the original content from the document, analysis based on the original content form the document, meta information of the document, and any other possible information that can be extracted from or generated based on the document. The information stored in the database can then be searched and retrieved when required. This embodiment allows different types of documents to be stored in different and specialized databases and will result in better search speed and accuracy compared to storing unprocessed information into one single database.

In step 501, a user message module receives a document. In step 502, a first LLM module may send a prompt to an LLM engine to process information from the document to create extracted information. There is no limitation to the type of information that can be extracted. For example, for a patent document, the extracted information may include abstract, claims, descriptions, inventor names, assignee names and other information. The steps to create a list of components mentioned in the patent document may also be included in the prompt, such that the LLM engine will provide the list and the first LLM module may also send the list as extracted information to step 503. In another example, for a legal affidavit, names, financial figures, locations, events and other information may be extracted. A chronological list of events may also be created by the first LLM. For product manuals, product name, parts name, installation procedures, maintenance procedures, and other information may be extracted. The replies from the LLM engine will be sent to the second LLM module.

There is no limitation that the tasks performed by the first LLM module may be completed in one prompt sent to the LLM engine. It is possible, for example, that multiple prompts with different sections of the document may be sent to different LLM engines to analyze. The replies may then be grouped for a final processing before sending to step 503.

In step 503, the second LLM module working with a branch module routes a different set of extracted information to different databases. For example, for a patent document, the entire original text of the patent document is sent to database 504a. Database 504a may index the entire original patent document for easy full-text search. The meta information of the patent, such as inventor names, assignee names, title, application date, priority date, and publication date, may be sent to database 504b. The summary of the patent may be sent to database 504c, which is a vector database, for indexing.

In one alternative embodiment, step 503 may be modified without using the second LLM if the branch module is capable of routing the extracted information in step 502 to the correct databases.

For a list of documents, all steps in FIG. 5 are repeated all documents are processed and stored into the databases.

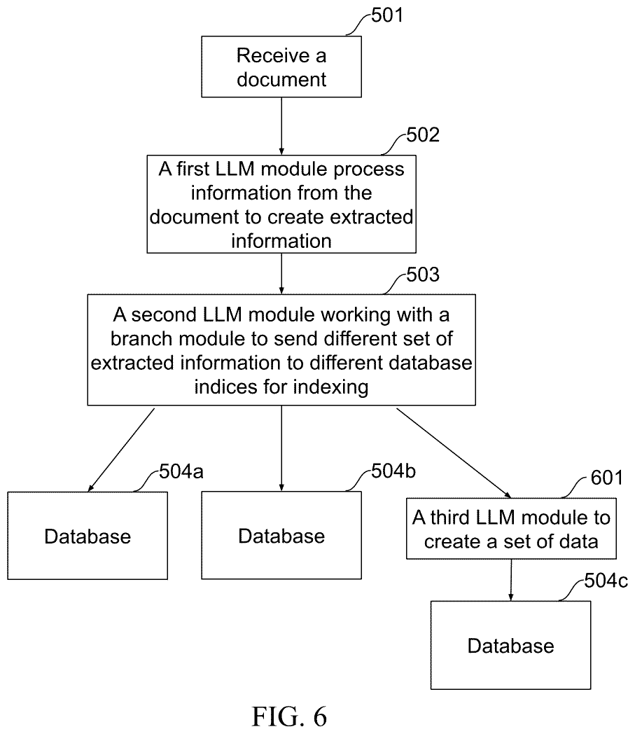

FIG. 6 illustrates one of alternative embodiments to the embodiment illustrated in FIG. 5. Step 601 is added to use a third LLM module to create a set of data based on the original content of the document, the outputs from the first LLM module, outputs from the second LLM module, and other information. The other information may be retrieved from another database, may be created for analytical purposes, and maybe for changing data format. There is no limitation of prompts to be used by and output types of the third LLM module.

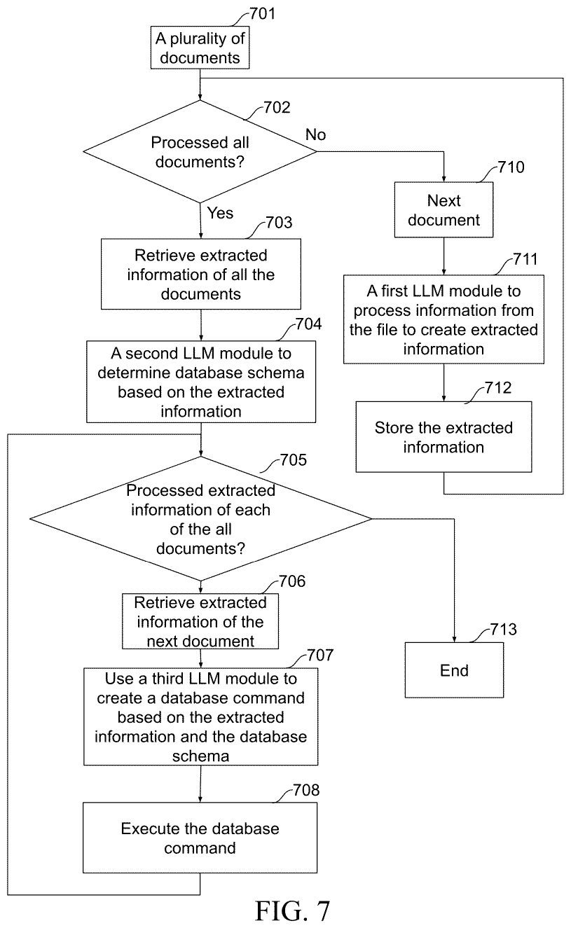

Databases, as illustrated in the embodiments of FIG. 5 and FIG. 6, are important in workflows that require data retrieval. However, one of the challenges is the creation of database schema. It is even more difficult to determine the database schema when processing a large number of unstructured documents, documents created by different authors, and documents with incorrect or missing information. FIG. 7 illustrates one of the embodiments of the present invention to resolve this problem.

In a workflow illustrated by the flowchart in FIG. 7, the goal is to store information of documents to at least one database. In step 701, there are a plurality of documents uploaded to the system to be processed by the workflow. In step 702, when there are documents remaining to be processed, step 710 will be performed, otherwise step 703 will be performed.

In step 711, similar to step 502, a first LLM module may send a prompt to a LLM engine to process information from the document to create extracted information. There is no limitation to the type of information that can be extracted. The extracted information will be stored in step 712. Steps 710 to 712 are repeated until all documents are processed.

In step 703, the extracted information of all documents is retrieved by a search module and processed by a second LLM module in step 704. In step 704, the second LLM module sends the extracted information and an instruction as a prompt to a LLM engine to instruct the LLM engine to create a schema. One of the instruction examples is: “Create a SQL table schema based on the information below”. There is no limitation that only SQL table schema can be created. There is also no limitation that only one database schema can be created. Another instruction example: “Create two XML schemas. The first schema is for storing personal information and the second schema is for storing contract clauses.” There is also no limitation that the tasks performed by the second LLM module must be completed by one LLM module. It is possible that a plurality of LLM modules may be used to achieve database schema creation.

After step 704 is performed, a database schema should be created. In step 705, the system will determine if it has processed extracted information of each of all documents. If not, a search module retrieves extracted information of the next document in step 706. In step 707, a third LLM module sends a prompt with an instruction, database schema, and extracted information of the document to create a database command to insert the extracted information to a database. One of the instruction examples is: “Create a SQL INSERTION command to insert the extracted information using the schema provided.” There is no limitation that only one database command must be created. There is also no limitation that one database is used. For example, the third LLM module may send one prompt to the LLM engine to create a database command to add certain extracted information to a first database and send another prompt to another LLM engine to create another database command to update information of a second database.

It is also possible a branch module may work the third LLM module to route different extracted information to different databases to store, similar to step 503.

In step 708, a database module may send the database command to a database to execute. The database module is similar to a search module that can communicate with a database, but is able to send database commands to databases, including insertion, update, delete, and search. A database module may be realized by Python programming language or similar programming language. The configuration to the database module is also similar to search module configuration that should include the database connection information.

When all extracted information is stored at step 708, the workflow will be completed in step 713.

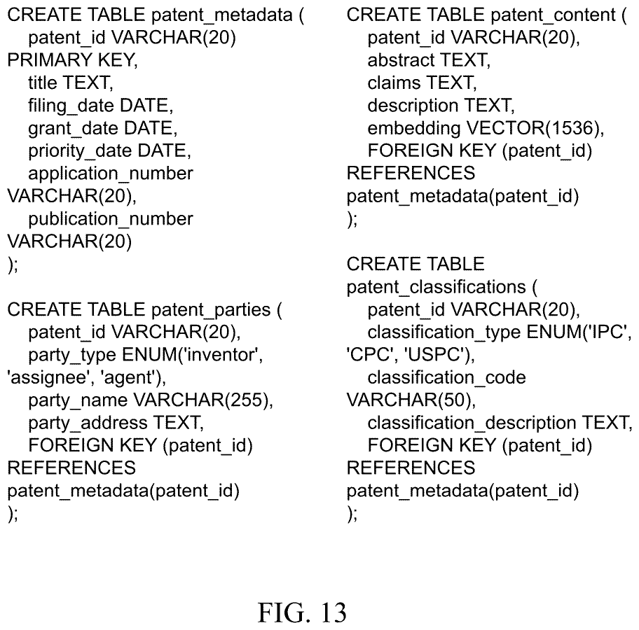

FIG. 13 illustrates an exemplary schema that expected to be produced by the second LLM module at step 704.

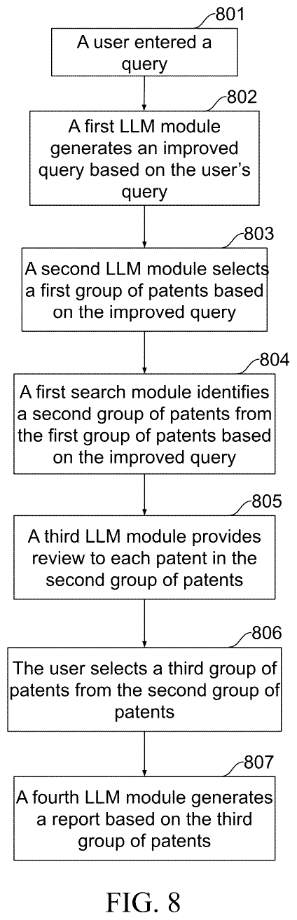

FIG. 8 illustrates a patent search workflow embodiment of the present invention. The workflow is not limited to patent search but also applicable to other types of information search, such as legal judgements, compliances, and technical support.

In step 801, a user entered a query to a user message module. For example, a user may enter “how to improve wireless communication capacity?” as the query.

In step 802, a first LLM module generates an improved query based on the user's query entered in step 801. The first LLM module may send a prompt with an instruction and the user's query to a LLM engine. An example of the instruction is: “Generate an improved query to allow better database search using a vector database for the provided query.” The reply from the LLM engine may become an improved query.

In step 803, a second LLM module selects the first group of patents based on the improved query. As there are millions of patents, better search results may be achieved by limiting the number of patents to be searched. One of the common methods for selection is to filter out patents that do not belong to a certain International Patent Classification (IPC) or filter out patents that are filed after a certain date, or to include patents that belong to certain assignees. In one example, the selection is based on keyword search.

In one illustration, a patent database has one million patents, after the selection in step 803, the first group of patents has about 50,000 patents. This reduces the number of patents that need to be considered significantly.

In step 804, a first search module identifies a second group of patents from the first group of patents based on the improved query. The first search module may send the query to a database that has the first group of patents. There are myriad algorithms to identify based on the improved query, including using Okapi BM25 (BM is an abbreviation of best matching), term frequency-inverse document frequency, and cosine similarity. The common choice of databases includes Solr, Elasticsearch, PostgreSQL, Quadrant and Weaviate. After the identification, the number of patents in the second group of patents should be fewer than the number of patents in the first group. Continuing the illustration, the number of patents in the second group of patents is about 2,000 patents.

In step 805, a third LLM module provides review to each patent in the second group of patents. The third LLM module sends a prompt with an instruction, the improved query and contents of the patent to an LLM engine. The purpose of the instruction is to provide a review. In one example, the instruction is: “explain the relevancy of the patent below to the improved query.” In another example, the instruction is: “explain how the patent below resolves the problem described in the improved query.” Step 805 should continue until all patents in the second group of patents are reviewed or until it is interrupted.

In step 806, the user selects a third group of patents from the second group of patents. The reviews from step 805 may be displayed to the user. For example, the title, review, inventor names and abstract of the patents are displayed. The reviews may help the users to make better selections. The selected patents become the third group of patents. Continuing the illustration, the user may have selected 500 patents.

In step 807, a fourth LLM module generates a report based on the third group of patents. The third LLM module sends a prompt with an instruction, reviews of selected patents and contents of the selected patent to an LLM engine. The purpose of the instruction is to provide a report on the selected patents. In one example, the instruction is: “produce a report to explain how the selected patents and their reviews help to answer the improved query.” In another example, the instruction is: “Select the best three patents that are most relevant to the improved query based on the patents provided.”

In an alternative embodiment, the selection in step 806 is performed by an LLM engine based on a prompt sent by a LLM module, instead of by a user.

In one option, the total number of words in the third group of patents may be too large, that is more than the allowed number of words that a LLM engine can process. In such cases, the patents may be summarized or truncated to reduce the number of words. In another option, only the first claim of the patents is sent by the LLM module to the LLM engine.

In one embodiment, instead of patents being processed, contracts are being processed. Therefore, in steps 801 to 807, all references to patents are replaced by contracts. A lawyer may want to find sample clauses about a topic. The lawyer, for example, may enter a query, “find sample clauses for indemnification of intellectual property infringements.” in step 801. The database may comprise contracts drafted by the law firm, instead of comprising patents.

Below illustrates an exemplary scheme for contracts that expected to be produced by the second LLM module at step 704.

```
<? xml version=“1.0” encoding=“UTF-8”?>
<xs:schema xmlns:xs=“http://www.w3.org/2001/XMLSchema”>
  <xs:element name=“contract”>
    <xs:complexType>
      <xs:sequence>
        <xs:element name=“metadata”>
          <xs:complexType>
            <xs:sequence>
              <xs:element name=“contract_id” type=“xs:string”/>
              <xs:element name=“contract_type” type=“xs:string”/>
              <xs:element name=“effective_date” type=“xs:date”/>
              <xs:element name=“expiration_date” type=“xs:date”/>
              <xs:element name=“status” type=“xs:string”/>
            </xs:sequence>
          </xs:complexType>
        </xs:element>
        <xs:element name=“parties”>
          <xs:complexType>
            <xs:sequence>
              <xs:element name=“party” maxOccurs=“unbounded”>
                <xs:complexType>
                  <xs:sequence>
                    <xs:element name=“party_name” type=“xs:string”/>
                    <xs:element name=“party_type” type=“xs:string”/>
                    <xs:element name=“party_address” type=“xs:string”/>
                    <xs:element name=“party_contact” type=“xs:string”/>
                  </xs:sequence>
                </xs:complexType>
              </xs:element>
            </xs:sequence>
          </xs:complexType>
        </xs:element>
        <xs:element name=“clauses”>
          <xs:complexType>
            <xs:sequence>
              <xs:element name=“clause” maxOccurs=“unbounded”>
                <xs:complexType>
                  <xs:sequence>
                    <xs:element name=“clause_id” type=“xs:string”/>
                    <xs:element name=“clause_type” type=“xs:string”/>
                    <xs:element name=“clause_title” type=“xs:string”/>
                    <xs:element name=“clause_content” type=“xs:string”/>
                    <xs:element name=“clause_category” type=“xs:string”/>
                  </xs:sequence>
                </xs:complexType>
              </xs:element>
            </xs:sequence>
          </xs:complexType>
        </xs:element>
      </xs:sequence>
    </xs:complexType>
```

In another embodiment, instead of patents being processed, technical documents and support tickets are being processed. Therefore, in steps 801 to 807, all references to patents are replaced by technical documents and support tickets.

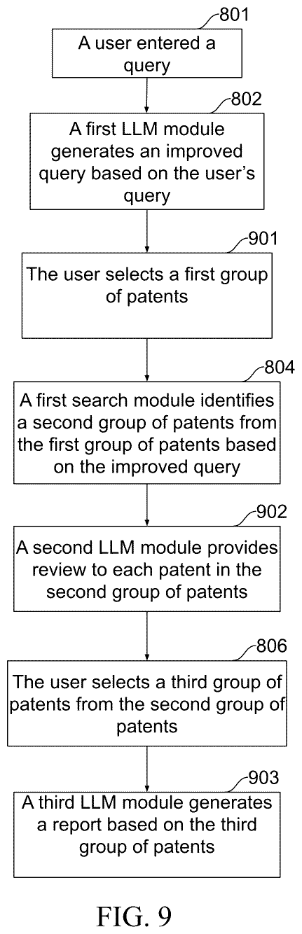

FIG. 9 illustrates an alternative patent search workflow embodiment to the embodiment illustrated in FIG. 8. Steps 803, 805 and 807 are replaced by steps 901, 902 and 903. In step 903, the user selects a first group of patents instead of relying on using a LLM module in step 803. A user may enter a selection criteria and/or filtering criteria to limit the number of patents in the first group of patents. The user may also manually select the patents.

In step 902, a second LLM module is used instead of a third LLM module is used in step 805. In step 903, a third LLM module is used instead of a fourth LLM module is used in step 807.

There is no limitation that step 802 must be performed before step 901. The user may select the first group of patents prior to the generation of the improved query. This is because the user may not need the improved query to help to select.

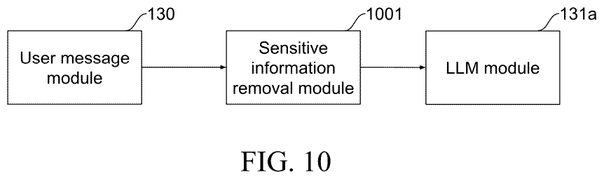

FIG. 10 illustrates one of the embodiments of the present invention based on the embodiment illustrated in FIG. 1. Sensitive information removal module 1001 is added to the workflow after user message module 130. Sensitive information is configured to remove sensitive information from inputs and produce an output that has no sensitive information. The definition of sensitive information may be defined by a sensitive information removal module configuration.

To remove sensitive information, such as names and birth dates, from messages, such as user provided messages, documents, medical reports, affidavits, can be realized using Natural Language Processing (NLP) techniques. Python has libraries like spaCy and regex. spaCy provides pre-trained models for named entity recognition (NER), which can automatically identify and extract entities such as names, dates, and other personally identifiable information (PII) from text. For example, Sensitive information removal module 130 may be realized by using spaCy to detect names with its built-in NER model, then redact or replace these names with a placeholder like “[REDACTED]”. Similarly, birth dates and other sensitive information can be identified using regular expressions, which allow you to match date formats like “MM/DD/YYYY” or “YYYY-MM-DD” and replace them accordingly.

Alternatively, LLMs can be trained or fine-tuned to recognize sensitive information by providing them with annotated examples of the text. For instance, an LLM engine with such an LLM can identify names, dates, and other personal information and then replace or obscure these entities automatically. This approach can be more flexible and accurate than traditional NER models because LLMs can understand the broader context in which the sensitive information appears, making them capable of handling edge cases, such as nicknames or ambiguous references.

In another example, a database-driven approach can be used for more controlled redaction, where sensitive information is stored in a database, and the text is checked against this data before redacting it from the message. For entity matching, a database could store lists of known names, birth dates, addresses, and other sensitive data. When processing the affidavit, the system would match the text against the database and identify the PII. For cross-referencing, the message is cross-referenced with the database to locate known sensitive information. For example, if a name or date of birth appears in the message, it is checked against the database and replaced with “[REDACTED]” if a match is found.

For auditing and compliance purposes, the event of sensitive removal can also be logged to provide an audit trail for compliance with data protection regulations, such as GDPR or CCPA.

In another embodiment, the sensitive information removal module may also be added to the workflow before any information is leaving the system, such as sending a prompt to a LLM engine and storing information to a database. This may reduce the risk of leaking out sensitive information.

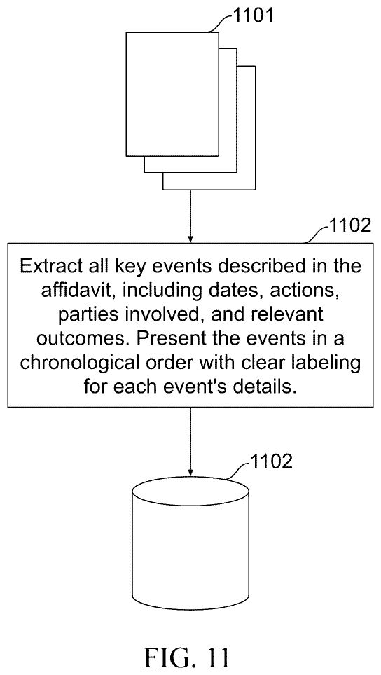

FIG. 11 illustrates one of the embodiments of the present invention. Documents 1101 are received by a user message module. For illustrations, documents 1101 comprises a plurality of affidavits of a commercial litigation case. Then an LLM module will send a prompt to an LLM engine. The prompt comprises an instruction shown in instruction 1102 and an affidavit. The LLM engine will process the prompt and provide a reply. The reply should include the key events of the affidavit. Then key events are then stored to database 1102 using a database module. After all affidavits in documents 1101 are processed, all key events from the affidavits should be recorded in database 1102. The database can then be used for searching.

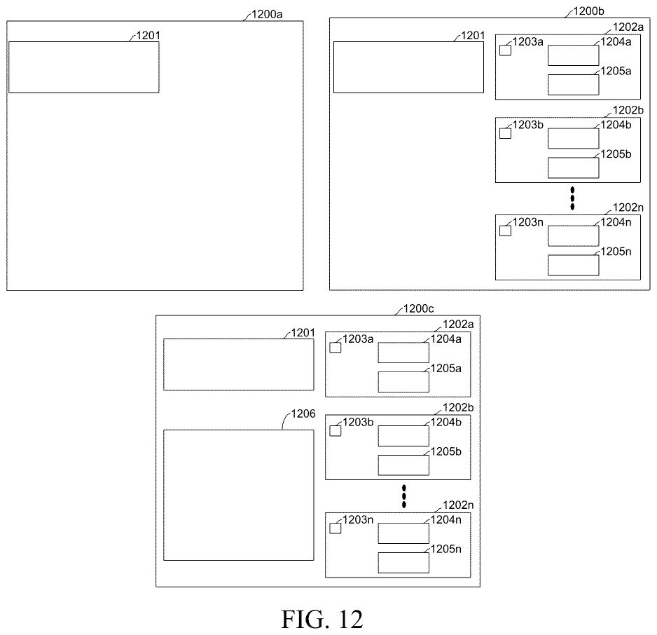

FIG. 12 illustrates a user interface of one of the embodiments of the present invention and could be viewed in conjunction with FIG. 8. Screen 1200a is the initial screen that has text box 1201. A user may enter a query in text box 1201 in step 801. A user message module will receive the query. After the query is entered, screen 1200a is updated to screen 1200b.

In screen 1200b, the query is still in text box 1201. Boxes 1202a-n will also appear after the query is performed and search results are available. The query is forwarded by the user message module to the first LLM module in step 802. After steps 802 to 805 are performed, patent information including the reviews will appear in text boxes 1204a to 1204n. In step 806, the user may select the patents using checkbox 1203a-n. If the user is only interested in the patent appearing in text box 1202b, for example, the user can check checkbox 1203b and leave the other checkbox unchecked. Not illustrated in the embodiment of FIG. 8, text boxes 1205a-n allows the user to input the user's comments to the corresponding patents.

In one alternative example, the query is changed to the improved query generated by a LLM module, such as in step 802. A user may change the improved query before step 803 is performed.

When the selection is completed by the user, step 807 will be performed. The fourth LLM module may send the prompt, which may comprise the improved query created in step 802, report creation instruction, contents of the third group of patents, reviews and user's comments to create the report. When the report is received by the fourth LLM module, it will then be sent to a presentation module, which will show the report in box 1206. There is no limitation that the report must be based on contents, reviews and user's comments, fewer or more materials will be provided. However, the number of words that can be in a prompt is usually limited by the LLM engine.

The user interface illustrated in FIG. 12 may be modified, for example, for the embodiment illustrated in FIG. 9. A list of patents may appear in a box for the user to select in step 901. Some pull down menus, text boxes, buttons may be used together to create selection criteria and/or filtering criteria.

The user interface may also be modified for different types of information to be searched and analyzed.

In one example, the workflow is adapted for medical diagnosis based on patient symptoms, test results, and medical history, where the user interface is customized for healthcare professionals. The workflow follows a similar structure to the patent search method, but instead of searching for patents, it searches for relevant medical diagnoses, research, and potential treatment recommendations. The medical diagnosis may also be applied to Chinese medicine.

Screen 1200a is the initial screen where a medical professional can enter patient-related information. Text box 1201 allows the user (a healthcare professional) to input a detailed query, such as “chronic cough and weight loss in a smoker” or “persistent headache with blurred vision.” The query is forwarded to the first LLM module (Medical Diagnosis module).

After the query is entered, screen 1200a is updated to screen 1200b. In screen 1200b, the entered query remains visible in text box 1201, and a list of possible diagnoses or medical conditions appears in boxes 1202a-n based on the query. For instance, the system could suggest differential diagnoses such as “lung cancer,” “tuberculosis,” or “chronic obstructive pulmonary disease (COPD)” and explain why such diagnoses are determined. In one alternative example, the query is changed to the improved query generated by a LLM module, such as in step 802.

The query is processed by the LLM module to instruct a LLM engine to analyze related medical research, clinical trial data, and relevant patient cases based on the query. Text boxes 1204a-n display these potential diagnoses along with detailed descriptions of each condition, including typical symptoms, risk factors, and potential treatment methods.

The medical professional can then select the diagnoses interested in by checking corresponding checkboxes 1203a-n. Additionally, text boxes 1205a-n may be provided for the user to input personal notes or comments about each diagnosis or condition.

After the medical professional completes the selection of diagnoses and associated information, step 807 is performed. The fourth LLM module will send a prompt to create a report based on the improved query, selected diagnoses, associated medical information, and user comments. This report may include potential next steps in diagnosis, recommended tests, or treatment plans. The report will be displayed in box 1206 on the user interface. The system may also suggest possible follow-up actions, such as scheduling specific diagnostic tests or referring the patient to a specialist.

In one alternative example, the user interface may also be adapted for different types of medical conditions or specialties (e.g., cardiology, dermatology, infectious diseases). For example, the user interface could be modified to include pull-down menus or dropdowns for selecting symptoms, medical history, or patient demographics (age, gender, etc.). Filtering criteria based on these parameters may help narrow down the list of possible diagnoses. The system could also suggest medical literature, research articles, or clinical guidelines relevant to the selected diagnosis, which can be reviewed by the healthcare professional for further decision-making.

Additionally, the system can be configured to incorporate real-time medical databases such as PubMed, Mayo Clinic guidelines, or other trusted medical resources to enhance the accuracy and relevance of the search results.

This embodiment ensures that healthcare professionals have a comprehensive tool to support decision-making in medical diagnosis, incorporating both patient-specific information and up-to-date clinical research.

In one example, the workflow can be adapted to accommodate the unique diagnostic framework of Traditional Chinese Medicine (TCM). In this embodiment, the user interface can be tailored to include inputs for TCM-specific parameters such as “tongue appearance,” “pulse diagnosis,” and “pattern identification” (e.g., Yin deficiency, Qi stagnation, etc.). When a query is entered by a practitioner, the system can analyze these inputs alongside conventional medical data to propose potential TCM diagnoses, such as specific syndromes or imbalances. The LLM module could then process and integrate both TCM theoretical concepts and modern clinical research to suggest herbal formulas, acupuncture points, and dietary recommendations aligned with TCM treatment protocols. The report generated would include detailed descriptions of the TCM diagnoses, treatment strategies, and relevant studies on their efficacy. Additionally, the system could be designed to respect TCM's holistic approach by considering lifestyle factors, emotional states, and environmental influences in its analysis. This adaptation would allow practitioners to benefit from a more comprehensive, integrative diagnostic tool that bridges the gap between TCM and modern healthcare practices.

What is claimed is:

1. A method of configuring a computing system to generate a report using a large language model (LLM), comprising:
a) receiving a message module configuration for a user message module, wherein the user message module is configured to receive user messages; wherein the message module configuration comprises a message order identification and a message string;
b) receiving LLM processing module configurations for a plurality of LLM processing modules, wherein each LLM processing module is individually configured to send prompts to an LLM engine and receive responses; wherein a LLM processing module configuration comprises a LLM processing module identification, a LLM processing module output format type and LLM processing module output format schema;
c) receiving search module configurations for a plurality of search modules, wherein each search module is individually configured to retrieve documents from a database; wherein a search module configuration comprises identification of a database and maximum of number of search results;
d) receiving a configuration for at least one presentation module, wherein the presentation module is configured to combine the outputs from at least one search module and at least one LLM processing module; wherein a presentation module configuration comprises identification of the at least one search module and identification of at least one LLM processing module;
e) receiving a flowchart configuration defining the message pathways among the user message module, the LLM processing modules, the search modules, and the presentation module;
f) configuring the computing system to execute the flowchart, wherein the user message module, the LLM processing modules, the search modules, and the presentation module work in coordination to generate the report;
g) when outputs from the at least one LLM processing module does not conform to the LLM processing module output format schema, configuring the computing system to modify the outputs from the at least one LLM processing module to conform to the LLM processing module output format schema.

2. The method of claim 1, further comprising: configuring the computing system to generate debug information for each module, wherein the debug information includes the inputs provided to and the outputs generated by each of the user message module, the LLM processing modules, the search modules, and the presentation module during the execution of the flowchart.

3. The method of claim 1, wherein each of the user message module, the plurality of LLM processing modules, the plurality of search modules, and the at least one presentation module is assigned automatically with a global unique identification and is allowed to be name with a local unique identification for referencing within the flowchart configuration.

4. The method of claim 1, further comprising: receiving a configuration for at least one branch module, wherein the branch module is configured to evaluate a branch condition based on an input received from a preceding module and, based on the evaluation, route the input to one of a plurality of subsequent modules defined in the flowchart configuration.

5. The method of claim 1, further comprising: receiving a configuration for a translation module, wherein the translation module is configured to receive a text string in a first language and utilize a large language model to translate the text string into a second language.

6. The method of claim 1, further comprising: converting codes contained within the outputs of the LLM processing modules or the search modules into images via the presentation module prior to generating the report.

7. The method of claim 1, further comprising: modifying outputs from the user message module, the LLM processing modules, and the search modules, before using the outputs according to the respective configurations, wherein modifying outputs comprises detecting and removing sensitive information using a sensitive information removal module.

8. The method of claim 1, further comprising: adding the LLM processing module output format schema to a prompt before sending the prompt to a LLM engine to instruct the LLM engine to generate the responses according to the LLM processing module output format schema.

9. The method of claim 1, wherein the user message is comprised of a plurality of files, and the method further comprises processing the plurality of files to extract information and storing the extracted information into a database to create a searchable library.

10. The method of claim 1, wherein outputs from the at least one LLM processing module are stored to a relational database, and the method further comprises receiving a database configuration comprising database connection information and database commands to insert the outputs into the relational database.

11. A computing system for generating a report using a large language model (LLM), comprising:
a) a processor; and
b) a memory storing instructions that, when executed by the processor, cause the computing system to perform operations comprising:
i. receiving a message module configuration for a user message module, wherein the user message module is configured to receive user messages; wherein the message module configuration comprises a message order identification and a message string;
ii. receiving LLM processing module configurations for a plurality of LLM processing modules, wherein each LLM processing module is individually configured to send prompts to an LLM engine and receive responses; wherein a LLM processing module configuration comprises a LLM processing module identification, a LLM processing module output format type and LLM processing module output format schema;
iii. receiving search module configurations for a plurality of search modules, wherein each search module is individually configured to retrieve documents from a database; wherein a search module configuration comprises identification of a database and maximum of number of search results;
iv. receiving a configuration for at least one presentation module, wherein the presentation module is configured to combine the outputs from at least one search module and at least one LLM processing module; wherein a presentation module configuration comprises identification of the at least one search module and identification of at least one LLM processing module;
v. receiving a flowchart configuration defining the message pathways among the user message module, the LLM processing modules, the search modules, and the presentation module;
vi. configuring the computing system to execute the flowchart, wherein the user message module, the LLM processing modules, the search modules, and the presentation module work in coordination to generate the report; and
vii. when outputs from the at least one LLM processing module do not conform to the LLM processing module output format schema, configuring the computing system to modify the outputs from the at least one LLM processing module to conform to the LLM processing module output format schema.

12. The computing system of claim 11, wherein the instructions further cause the computing system to: generate debug information for each module, wherein the debug information includes the inputs provided to and the outputs generated by each of the user message module, the LLM processing modules, the search modules, and the presentation module during the execution of the flowchart.

13. The computing system of claim 11, wherein each of the user message module, the plurality of LLM processing modules, the plurality of search modules, and the at least one presentation module is assigned automatically with a global unique identification and is allowed to be named with a local unique identification for referencing within the flowchart configuration.

14. The computing system of claim 11, wherein the instructions further cause the computing system to: receive a configuration for at least one branch module, wherein the branch module is configured to evaluate a branch condition based on an input received from a preceding module and, based on the evaluation, route the input to one of a plurality of subsequent modules defined in the flowchart configuration.

15. The computing system of claim 11, wherein the instructions further cause the computing system to: receive a configuration for a translation module, wherein the translation module is configured to receive a text string in a first language and utilize a large language model to translate the text string into a second language.

16. The computing system of claim 11, wherein the instructions further cause the computing system to: convert codes contained within the outputs of the LLM processing modules or the search modules into images via the presentation module prior to generating the report.

17. The computing system of claim 11, wherein the instructions further cause the computing system to: modify outputs from the user message module, the LLM processing modules, and the search modules, before using the outputs according to the respective configurations, wherein modifying outputs comprises detecting and removing sensitive information using a sensitive information removal module.

18. The computing system of claim 11, wherein the instructions further cause the computing system to: add the LLM processing module output format schema to a prompt before sending the prompt to a LLM engine to instruct the LLM engine to generate the responses according to the LLM processing module output format schema.

19. The computing system of claim 11, wherein the user message is comprised of a plurality of files, and the instructions further cause the computing system to process the plurality of files to extract information and store the extracted information into a database to create a searchable library.

20. The computing system of claim 11, wherein outputs from the at least one LLM processing module are stored to a relational database, and the instructions further cause the computing system to receive a database configuration comprising database connection information and database commands to insert the outputs into the relational database.
